(19) United States
(12) Patent Application Publication
(10) Pub. No.: US 2023/0018996 A1
(43) Pub. Date: Jan. 19, 2023

(54) METHOD, DEVICE, AND COMPUTER PROGRAM FOR PROVIDING DRIVING GUIDE BY USING VEHICLE POSITION INFORMATION AND SIGNAL LIGHT INFORMATION

(71) Applicant: RIDEFLUX INC., Jeju-si (KR)

(72) Inventors: Himchan CHO, Hanam-si (KR); Hawook JEONG, Jeju-si (KR); Junghee PARK, Jeju-si (KR); Ho YUN, Jeju-si (KR)

(73) Assignee: RIDEFLUX INC., Jeju-si (KR)

(21) Appl. No.: 17/935,481

(22) Filed: Sep. 26, 2022

Related U.S. Application Data
(63) Continuation of application No. PCT/KR2021/002516, filed on Feb. 26, 2021.

(30) Foreign Application Priority Data
Mar. 26, 2020 (KR) 10-2020-0036896

(51) Int. Cl. G01C 21/36; G01C 21/34; G06T 7/73; G06V 20/58; G06V 20/56

(52) U.S. Cl. CPC G01C 21/3658; G01C 21/3492; G06T 7/74; G06V 20/584; G06V 20/588; G06T 2207/30256

(57) ABSTRACT

Provided are a method, a device, and a computer program for providing a driving guide by using vehicle position information and signal light information. A method for providing a driving guide by using vehicle position information and signal light information according to various embodiments of the present invention is a method performed by a computing device. The method may comprise the steps of: collecting image data obtained by photographing a space where a vehicle is currently driving; determining a current driving lane of the vehicle by using the image data and vehicle position information; and providing a driving guide for the vehicle by using the current driving lane of the vehicle.

### CROSS-REFERENCE TO RELATED APPLICATION

The present application is a continuation of International Patent Application No. PCT/KR2021/002516, filed on Feb. 26, 2021, which is based upon and claims the benefit of priority to Korean Patent Application No. 10-2020-0036896, filed on Mar. 26, 2020. The disclosures of the above-listed applications are hereby incorporated by reference herein in their entirety.

### TECHNICAL FIELD

Various embodiments of the present invention relate to a method, apparatus, and computer program for providing a travelling guide using vehicle position information and traffic light information.

### BACKGROUND ART

As vehicles are increasingly being used, there have been active development of various sensors and electronic devices (e.g., an advanced driver assistance system (ADAS), a travelling route guide service providing system, etc.) for the convenience of users who drive vehicles.

In particular, a travelling route guide service providing system (e.g., a navigation system), which is a system for generating an optimal travelling route from a current position of a driver and vehicle to a destination and providing the route, is recognized as an essential device for a vehicle.

In general, the conventional travelling route guide service providing system receives a destination directly from the driver, and calculates an optimal distance from the current position of the vehicle (e.g., position information obtained from a position sensor provided in the vehicle or provided in a terminal of the driver) to the input destination and provides the calculated optimal distance.

However, in the case of the conventional travelling route guide service providing system, since the position information obtained from the vehicle has an error that amounts to several meters, and only a rough travelling route of the vehicle is provided, there is difficulty in providing a travelling guide for guiding detailed operations based on accurate position information of the vehicle.

For example, when the vehicle deviates from a preset travelling route (e.g., a travelling route to a preset destination), a new travelling route is provided according to the position of the vehicle. However, in the case of the conventional travelling route guide service providing system, since it is difficult to determine the accurate position of the vehicle, there is a problem that a new travelling route is provided by recognizing that the vehicle has deviated from the travelling route only after travelling outside the preset travelling route to some extent.

In addition, in the conventional travelling route guide service providing system, since it is difficult to obtain an accurate position from the vehicle, there is a limitation in providing more detailed guides (e.g., lane change, speed control, or the like) that are required while travelling a travelling route.

### DISCLOSURE

### Technical Problem

It is an object of the invention to provide a method, apparatus, and computer program for providing a travelling guide using vehicle position information and traffic light information that is capable of providing various types of travelling guides for the vehicle by determining a more precise position of the vehicle.

The technical objectives of the present invention are not limited to the above, and other objectives that are not described may become apparent to those of ordinary skill in the art based on the following description.

### Technical Solution

In order to solve the above problems, a method of providing a travelling guide using position information of a vehicle and traffic light information according to an embodiment of the present invention is a method performed by a computing device, the method including: collecting image data obtained by photographing a space in which a vehicle is currently travelling; determining a current travelling lane of the vehicle using the image data and position information of the vehicle; and providing a travelling guide for the vehicle using the current travelling lane of the vehicle.

In various embodiments, the providing of the travelling guide for the vehicle may include: determining whether a lane change is required and the number of required lane changes based on the current travelling lane of the vehicle and a travelling route preset in the vehicle; and when it is determined that the lane change is required, providing a travelling guide for guiding to change lanes by the determined number of required lane changes.

In various embodiments, the providing of the travelling guide for guiding to change lanes may include, when it is determined that the lane change is required, determining a lane change time point of the vehicle based on the preset travelling route, wherein the determined lane change time point may be corrected based on whether there is vehicle congestion on the preset travelling route.

In various embodiments, the providing of the travelling guide for the vehicle may include, when it is determined that the lane change is required, determining a lane change time point of the vehicle based on the preset travelling route, and when the lane change is not performed at the determined lane change time point, changing the preset travelling route based on the current travelling lane of the vehicle.

In various embodiments, the method may further include collecting signal information about one or more traffic lights located on a travelling route preset in the vehicle, wherein the providing of the travelling guide for the vehicle may include providing a travelling guide for guiding to start or stop the vehicle or guiding control of a speed of the vehicle based on at least one of the current travelling lane of the vehicle, the travelling route preset in the vehicle, and the signal information.

In various embodiments, the providing of the travelling guide for the vehicle may include, when the current travelling lane of the vehicle is a left turn-only lane, providing a travelling guide generated by considering only a left turn signal in the signal information; when the current travelling lane of the vehicle is a shared straight/left turn lane, providing a travelling guide generated by considering only a straight signal in the signal information or a travelling guide generated by considering only the left turn signal in the signal information according to the preset travelling route; when the current travelling lane of the vehicle is a right turn-only lane, providing a travelling guide generated by considering only the preset route regardless of the signal information; and when the current travelling lane of the vehicle is a shared straight/right turn lane, providing a travelling guide generated by considering only the straight signal according to the preset travelling route or a travelling guide generated by considering only the preset route regardless of the signal information.

In various embodiments, the collecting of the signal information about the one or more traffic lights may include: collecting position information about the one or more traffic lights located on the preset travelling route from precision map data including lanes, lane line information, and traffic light information for each of a plurality of roads; collecting the image data every preset unit time from a point in time at which a distance between the vehicle and the one or more traffic lights is less than or equal to a reference distance using the position information about the one or more traffic lights and a current position of the vehicle; and analyzing images for the one or more traffic lights included in the image data to collect the signal information about the one or more traffic lights.

In various embodiments, the determining of the current travelling lane of the vehicle may include: determining a current position of the vehicle and a moving direction of the vehicle using the position information of the vehicle; and analyzing a road on which the vehicle travels and surrounding geographical features included in the image data using a pre-trained artificial intelligence (AI) model to determine the current travelling lane of the vehicle.

In order to solve the above problems, an apparatus for providing a travelling guide using position information of a vehicle and traffic light information according to another embodiment of the present invention includes a memory and a processor, wherein the memory stores one or more instructions, and the processor executes the one or more instructions stored in the memory and performs the method of providing a travelling guide using position information of a vehicle and traffic light information according to the embodiment of the present invention.

In order to solve the above problems, a computer program according to another embodiment of the present invention is stored in a computer-readable recording medium to perform the method of providing a travelling guide using position information of a vehicle and traffic light information according to the embodiment of the present invention in combination with a computer which is hardware.

Other specific details of the present invention are included in the specification and the accompanying drawings.

### Advantageous Effects

According to various embodiments of the present invention, the method, apparatus, and computer program for providing a travelling guide using vehicle position information and traffic light information can determine a more accurate position of the vehicle by analyzing image data obtained by photographing a space in which the vehicle is travelling, and provide various types of information according to the determined accurate position of the vehicle.

The effects of the present invention are not limited to the effects described above, and other effects that are not described will be clearly understood by those skilled in the art from the following description.

### DESCRIPTION OF DRAWINGS

FIG. 1 is a diagram illustrating a system for providing a travelling guide using vehicle position information and traffic light information according to an embodiment of the present invention.

FIG. 2 is a hardware configuration diagram illustrating an apparatus for providing a travelling guide according to another embodiment of the present invention.

FIG. 3 is a flowchart showing a method of providing a travelling guide using vehicle position information and traffic light information according to another embodiment of the present invention.

FIGS. 4 and 5 are diagrams illustrating a form in which an apparatus for providing a travelling guide analyzes image data according to various embodiments of the present invention.

FIG. 6 is a diagram schematically illustrating a form of precision map data including lanes, lane line information, and traffic light information for each of a plurality of roads according to various embodiments.

FIG. 7 is a flowchart showing a method of providing a travelling guide according to a need to change lanes, according to various embodiments.

FIG. 8 is a flowchart showing a method of providing a travelling guide using traffic light information according to various embodiments.

### MODES OF THE INVENTION

Hereinafter, the advantages and features of the present invention and ways of achieving them will become readily apparent with reference to the following embodiments described in detail in conjunction with the accompanying drawings. However, the present invention is not limited to such embodiments and may be embodied in various forms. The embodiments to be described below are provided only to make the disclosure of the present invention complete and assist those of ordinary skill in the art in fully understanding the scope of the present invention, and the scope of the present invention is defined only by the appended claims.

Terms used herein are used for describing the embodiments and are not intended to limit the scope and spirit of the present invention. It should be understood that the singular forms “a” and “an” in addition include the plural forms unless the context clearly dictates otherwise. The terms “comprises,” “comprising,” “includes,” and/or “including,” when used herein, specify the presence of stated features, integers, steps, operations, elements, components and/or groups thereof and do not preclude the presence or addition of one or more other features, integers, steps, operations, elements, components, and/or groups thereof. In connection with assigning reference numerals to elements in the drawings, the same reference numerals are used for designating the same elements throughout the specification, and the term “and/or” includes any one or combinations of the associated listed items. It should be understood that, although the terms “first,” “second,” etc. may be used herein to describe various elements, these elements are not limited by these terms. These terms are only used for distinguishing one element from another. For example, a first element could be a second element without departing from the scope of the present invention.

Unless otherwise defined, all terms (including technical and scientific terms) used herein have the same meanings as commonly understood by those of ordinary skill in the art to which this invention belongs. It should be further understood that terms, such as those defined in commonly used dictionaries, should not be interpreted in an idealized or overly formal sense unless expressly defined herein specifically.

In the embodiments, the term “unit” or “module” refers to a software element or a hardware element such as a field-programmable gate array (FPGA), an application-specific integrated circuit (ASIC), etc., and performs a corresponding function. It should, however, be understood that the term “unit” or “module” is not limited to a software or hardware element. A “unit” or “module” may be implemented in an addressable storage medium. A “unit” or “module” may in addition be configured to reproduce one or more processors. For example, a “unit” or “module” may include various types of elements (e.g., software elements, object-oriented software elements, class elements, task elements, etc.), segments (e.g., processes, functions, attributes, procedures, sub-routines, program code, etc.), drivers, firmware, micro-code, circuits, data, databases, data structures, tables, arrays, variables, etc. Functions provided by elements and “units” or “modules” may be formed by combining them into a smaller number of elements and “units” or “modules” or may be divided into additional elements and “units” or “modules.”

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the drawings. For example, when the device in the drawings is turned over, elements described as “below” or “beneath” other elements or features would then be oriented “above” the other elements or features. Thus, the term “below” can encompass both an orientation of above and below. The element may be otherwise oriented and the spatially relative descriptors used herein interpreted accordingly.

In the specification, a computer may be any type of hardware device including at least one processor, and may be understood to encompass software configurations operating in the corresponding hardware device according to embodiments. For example, a computer may be understood to be a smart phone, a tablet PC, a desktop, a notebook, a user client, or an application running on any of these devices, but is not limited thereto.

Hereinafter, embodiments of the present invention will be described in detail with reference to the accompanying drawings.

Each operation described in the specification is described as being performed by a specific component or computer, but the agent of each operation is not limited thereto, and at least some of the operations may be performed in different devices according to embodiments.

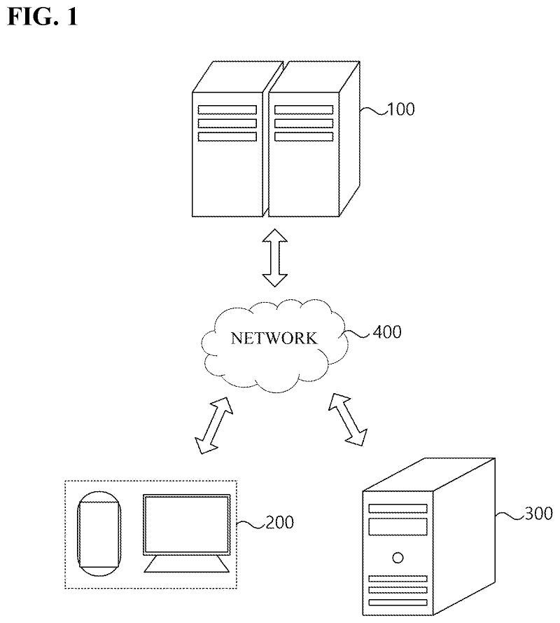

FIG. 1 is a diagram illustrating a system for providing a travelling guide using vehicle position information and traffic light information according to an embodiment of the present invention.

Referring to FIG. 1, a system for providing a travelling guide using vehicle position information and traffic light information according to the embodiment of the present invention may include an apparatus 100 for providing a travelling guide, a user terminal 200, and an external server 300.

Here, the system for providing a travelling guide using vehicle position information and traffic light information shown in FIG. 1 is provided according to the embodiment, and components thereof are not limited to the embodiment shown in FIG. 1, and when required, components may be added, changed or deleted.

In one embodiment, the apparatus 100 for providing a travelling guide may obtain image data of a space in which a vehicle is currently travelling and position information of the vehicle, and determine a current travelling lane of the vehicle using the position information and the image data of the vehicle. For example, the apparatus 100 for providing a travelling guide may use an artificial intelligence model, which is pre-trained from a plurality of pieces of image data including lanes, lane line information, and traffic light information for each of a plurality of roads as learning data, to analyze the image data of the space in which the vehicle is currently travelling, thereby determining a current position, a travelling direction, and a current travelling lane of the vehicle. However, the present invention is not limited thereto.

In an embodiment, the apparatus 100 for providing a travelling guide may provide a travelling guide for the vehicle based on a preset travelling route and a current travelling lane of the vehicle. For example, the apparatus 100 for providing a travelling guide may, when the vehicle is currently travelling in a straight-only lane with a need to proceed with a right turn, provide a travelling guide for guiding the vehicle, which needs to proceed with a right turn, to switch to a shared straight/right turn lane or a right turn-only lane.

In an embodiment, apparatus 100 for providing a travelling guide may provide a travelling guide for the vehicle based on a current travelling lane of the vehicle and signal information of traffic lights located on a preset travelling route. For example, the apparatus 100 for providing a travelling guide may provide a travelling guide for guiding to start or stop the vehicle or guiding control of the speed of the vehicle based on the current travelling lane of the vehicle and the signal information of traffic lights. However, the present invention is not limited thereto.

In an embodiment, the user terminal 200 may be connected to the apparatus 100 for providing a travelling guide through a network 400, and may receive the travelling guide from the apparatus 100 for providing a travelling guide and output the received travelling guide. For example, the user terminal 200 may include at least one of a smart phone, a tablet personal computer (PC), a laptop computer, a desktop PC, and an infotainment system of a vehicle having a display in at least a part thereof, and may output the travelling guide provided from the apparatus 100 for providing a travelling guide through the display. However, the present invention is not limited thereto, and the user terminal 200 may output the travelling guide provided from the apparatus 100 for providing a travelling guide in the form of audio through an audio output device (e.g., a speaker).

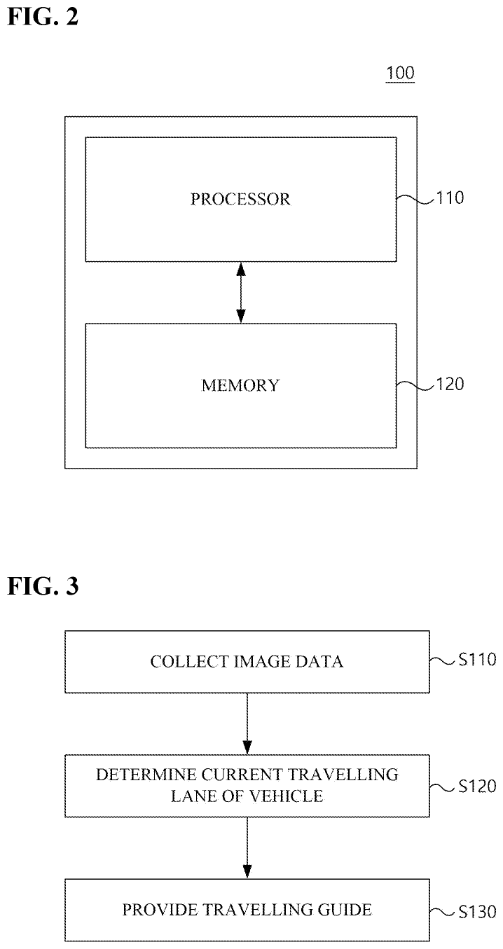

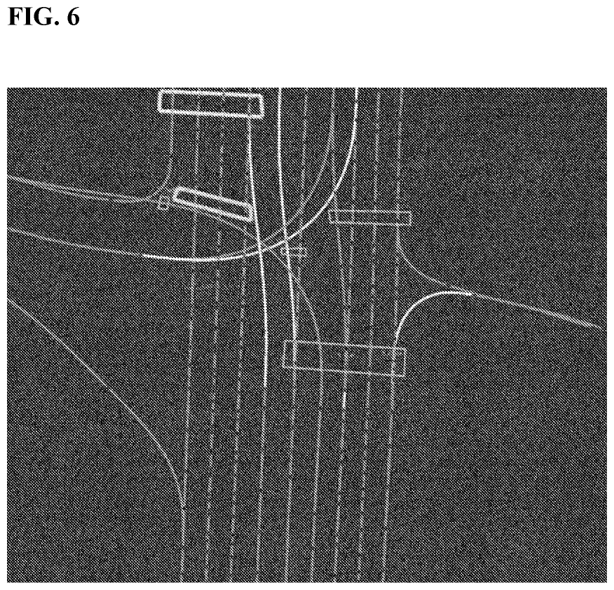

In an embodiment, the external server 300 may be connected to the apparatus 100 for providing a travelling guide through the network 400, and may provide various types of data required by the apparatus 100 for providing a travelling guide in the process of generating the travelling guide. For example, the external server 300 may store precision map data (e.g., FIG. 6) including lanes, lane line information, and traffic light information for each of a plurality of roads, and may provide the previous stored precision map data in the process of generating a travelling guide by apparatus 100 for providing a travelling guide. However, the present invention is not limited thereto. Hereinafter, an apparatus 100 for providing a travelling guide according to another embodiment of the present invention will be described with reference to FIG. 2.

FIG. 2 is a hardware configuration diagram illustrating a travelling guide providing apparatus according to another embodiment of the present invention.

Referring to FIG. 2, an apparatus 100 for providing a travelling guide (hereinafter, a “computing device 100”) according to another embodiment of the present invention may include a processor 110 and a memory 120. In various embodiments, the computing device 100 may further include a network interface (or a communication interface) (not shown), a storage (not shown), and a bus (not shown).

In an embodiment, the processor 110 may control the overall operation of respective components of the computing device 100. The processor 110 may include a central processing unit (CPU), a micro-processor unit (MPU), a micro controller unit (MCU), or any type of processor well known in the art.

In various embodiments, the processor 110 may perform an operation on at least one application or program for executing methods according to embodiments of the present invention. In various embodiments, the processor 110 may include one or more cores (not shown) and a graphics processing unit (not shown) and/or a connection route (e.g., a bus, etc.) for transmitting and receiving signals to and from other components.

In various embodiments, the processor 110 may further include a random-access memory (RAM) and a read-only memory (ROM) (not shown) for temporarily and/or permanently storing signals (or data) processed in the processor 110. In addition, the processor 110 may be implemented in the form of a system on chip (SoC) including at least one of a GPU, a RAM, and a ROM.

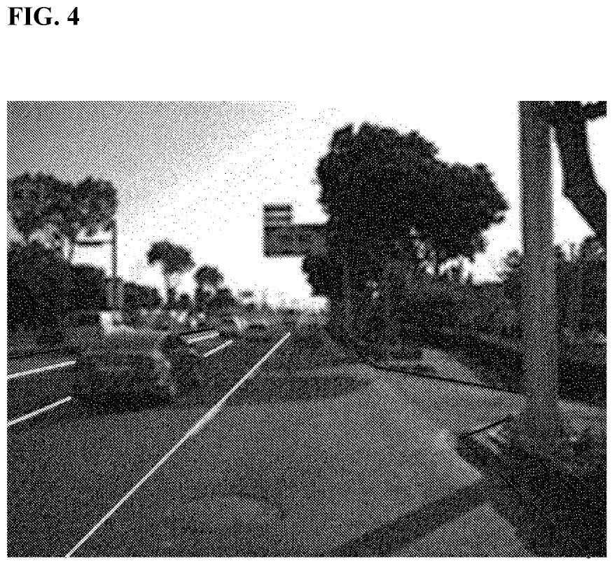

In one embodiment, the processor 110 may execute one or more instructions stored in the memory 120, to perform the method to be described with reference to FIGS. 3 to 8 (e.g., a method of providing a travelling guide using vehicle position information and traffic light information).

For example, the processor 110 may execute one or more instructions stored in the memory 120 to perform a method of providing a travelling guide using vehicle position information and traffic light information including: collecting image data obtained by photographing a space in which a vehicle is currently travelling; determining a current travelling lane of the vehicle using the image data and position information of the vehicle; and providing a travelling guide for the vehicle using the current travelling lane of the vehicle. However, the present invention is not limited thereto.

In one embodiment, the memory 120 may store various types of data, commands, and/or information. The memory 120 may store programs (one or more instructions) for processing and controlling the processor 110. Programs stored in the memory 120 may be divided into a plurality of modules according to functions.

In various embodiments, operations of a method or algorithm described in connection with an embodiment of the present invention may be implemented directly by hardware, by a software module executed by hardware, or by a combination of hardware and a software module. The software module may reside in a RAM, a ROM, an erasable programmable ROM (EPROM), an electrically erasable programmable ROM (EEPROM), a flash memory, a hard disk, a removable disk, a compact disc read only memory (CD-ROM), or any other type of computer-readable recording medium well known in the art to which the present invention pertains.

The components of the present invention may be implemented as a program (or application) to be executed in combination with a computer, which is hardware, and may be stored in a medium. The components of the present invention may be implemented in software programming or software components, and similarly, embodiments may be implemented in programming or scripting languages, such as C, C++, Java, assembler, etc., including various algorithms implemented in a combination of data structures, processes, routines or other programming components. Functional aspects may be implemented with algorithms running on one or more processors. Hereinafter, a method of providing a travelling guide using vehicle position information and traffic light information, which is performed by a computing device, will be described with reference to FIG. 3.

FIG. 3 is a flowchart showing a method of providing a travelling guide using vehicle position information and traffic light information according to another embodiment of the present invention.

Referring to FIG. 3, in operation S110, the computing device 100 may collect image data of a space in which the vehicle is currently travelling. For example, the computing device 100 may collect image data (e.g., an image, a video, etc.) photographed from at least one of a camera provided in a black box module of the vehicle, a camera module separately installed in the vehicle for image data capturing, a camera module provided in the user terminal 200, and a camera module (e.g., a front camera module or a rear camera module) internally provided in the vehicle.

In various embodiments, the computing device 100 may, upon destination information being input from a user, generate a preset travelling route, and automatically collect image data every preset unit time from a point in time at which the generated preset travelling route is provided. However, the present invention is not limited thereto.

In various embodiments, the computing device 100 may collect position information of the vehicle. For example, the computing device 100 may collect position information of the vehicle from a position sensor (e.g., a global positioning system (GPS) sensor) provided in the vehicle or the user terminal 200. However, the present invention is not limited thereto.

In operation S120, the computing device 100 may determine a current travelling lane of the vehicle using the image data and the position information of the vehicle obtained in operation S110.

In various embodiments, the computing device 100 may determine a current position of the vehicle and a moving direction of the vehicle using the position information of the vehicle. For example, the computing device 100 may obtain latitude and longitude values of the vehicle or position information represented by an x-coordinate and a y-coordinate based on latitude and longitude values of the vehicle from the position sensor of the vehicle. In addition, the computing device 100 may determine the moving direction of the vehicle based on the change in the position of the vehicle. However, the present invention is not limited thereto.

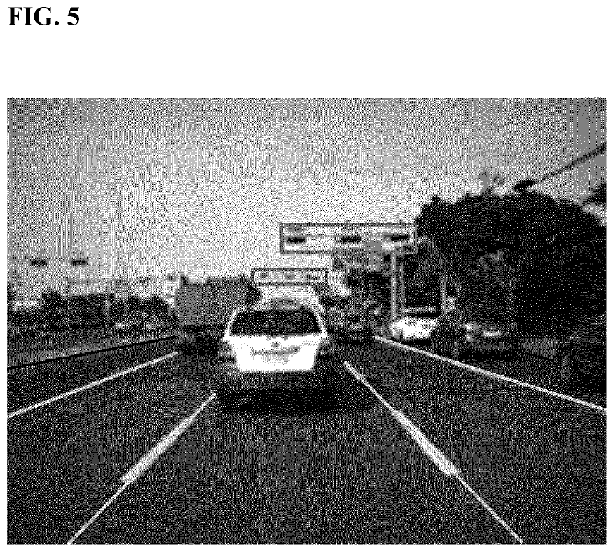

Thereafter, the computing device 100 may analyze a road on which the vehicle travels and surrounding geographical features included in the image data (e.g., FIGS. 4 and 5) obtained in operation S110 using a pre-trained AI model to determine the current travelling lane of the vehicle. For example, the computing device 100 may extract information about a lane line (e.g., a position of a lane line, an attribute of the corresponding lane line) from the image data obtained in operation S110 using the AI model, and identify a lane included in a road identified in the image data using the information about the lane line (e.g., identify an area between lane lines as one lane). To this end, the computing device 100 may train the AI model using a plurality of pieces of image data including lanes, lane line information, and traffic light information for each of a plurality of roads as learning data.

In various embodiments, the computing device 100 may train an AI model to determine a lane using a lane line of a road in image data. For example, the computing device 100 may train an AI model using a plurality of pieces of image data obtained by photographing lane lines of roads as learning data to allow the AI model to identify a lane line from the image data updated in operation S110 and determine an area between the identified lane lines as one lane. However, the present invention is not limited thereto.

In various embodiments, the computing device 100 may train an AI model to determine a lane using attributes (e.g., a photographed angle, size, shape, etc. of a geographical feature) of surrounding geographical features in the image data. For example, the computing device 100 may train an AI model using attribute data of a surrounding geographical feature for each travelling lane as learning data to allow the AI model to determine a lane according to the angle, size, and shape of the geographical feature included in the image data uploaded in operation S110. However, the present invention is not limited thereto.

In various embodiments, the computing device 100 may train an AI model to determine a lane according to a preset criterion in the image data. For example, the computing device 100 may set, as a criterion, any one of the geographical features (e.g., a sidewalk, a building, a street light, a median strip, a pedestrian safety fence, etc.) included in each of a plurality of pieces of image data, and train an AI model using data classifying a lane according to a relationship with the set criterion as learning data to allow the AI model to determine a lane using the relationship with the set criterion (e.g., the position away from the criterion) in the image data uploaded in operation S110. However, the present invention is not limited thereto.

In various embodiments, when information about a lane line is not extracted from the image data (e.g., a case of a road having no lane line, or a case of a lane line not properly identified due to an obstacle, such as a nearby vehicle), the computing device 100 may extract a surrounding geographical feature (e.g., a median strip, a sidewalk, a street tree, etc.) and use information about the surrounding geographical feature to identify a lane included in the road identified in the image data.

Thereafter, the computing device 100 may determine a current travelling lane of the vehicle using the lanes identified by analyzing the image data. When it is determined that the road identified in the image data is a four-lane road and the vehicle is travelling in the rightmost lane among the four lanes (e.g., FIG. 4), the computing device 100 may determine the current travelling lane of the vehicle as a fourth lane. In addition, when it is determined that the road identified in the image data is a five-lane road and there are two lanes on the left and two lanes on the right based on the current travelling lane of the vehicle, that is, the vehicle is determined to be travelling in the middle lane (e.g., FIG. 5), the computing device 100 may determine the current travelling lane of the vehicle as a third lane.

In various embodiments, the computing device 100 may determine the current travelling lane of the vehicle using the image data and the position information of the vehicle, but when it is determined that the all lanes of the road are not included in the image data, a criterion for determining a lane in the image data may be set, and the current travelling lane of the vehicle may be determined based on the set criterion.

When a large number of lanes are present on the road on which the vehicle travels or the photographing angle of the camera provided in the vehicle is narrow, all the lanes of the road may not be included in the image data collected from the camera, and in this case, it may not be accurately determined how many lanes are present in total or which lane is the current travelling lane of the vehicle.

In order to compensate for the above, the computing device 100 may set a criterion for determining a lane using various geographical features included in the image data, and determine the current travelling lane of the vehicle based on the set criterion.

For example, the computing device 100 may analyze the image data to set a criterion (e.g., a boundary line between a travelling road and a sidewalk, a median zone, etc.) for determining a lane, and determine a relationship (e.g., a relationship indicating the order of the current travelling lane of the vehicle on the left or on the right based on the preset criterion) between the lane on which the vehicle travels and the preset criterion.

Thereafter, the computing device 100 may determine the current travelling lane of the vehicle using the precision map data (e.g., FIG. 6) obtained from the external server 300. For example, the computing device 100 may identify the number of lanes on the road on which the vehicle is currently travelling using the current position of the vehicle and the precision map data, and determine which lane is the current travelling lane of the vehicle using the relationship information of the vehicle and lane information of the road obtained from the precision map data. However, the present invention is not limited thereto.

In various embodiments, the computing device 100 may use the number of lanes determined from the precision map data (e.g., FIG. 6) obtained from the external server 300 to verify the number of lanes determined through the image data analysis, and only when the number of lanes determined from the precision map data matches the number of lanes determined through the image data analysis, may the current travelling lane of the vehicle be determined. Here, when the number of lanes determined from the precision map data does not match the number of lanes determined through the image data analysis, the computing device 100 may reanalyze the previously analyzed image data or analyze new image data collected through operation S110. However, the present invention is not limited thereto.

That is, even when all lanes of the road are included in the image data, the computing device 100 may determine and verify the lane using the image data together with the precision map data obtained from the external server 300 to more accurately determine the current travelling lane of the vehicle.

In various embodiments, the computing device 100 may determine the current travelling lane of the vehicle based on the geographical feature information included in the image data. For example, even when the image data is photographed while travelling on the same road, the angle, size, and shape of the surrounding geographical feature may be photographed differently depending on which lane of the road the vehicle travels. Using this, the computing device 100 may determine the current travelling lane of the vehicle using the attributes (e.g., shape, angle, size, etc.) of the geographical feature included in the image data.

For example, the computing device 100 may collect image data photographed while travelling on each lane in a specific region, which is a learning target, as learning data, and may train an AI model for determining the current lane according to a photographed image based on the learning data. For example, the shape, size, angle, etc. of the surrounding geographical feature included in the photographed image may constitute a feature for determining a lane as described above, but the present invention is not limited thereto.

In various embodiments, the computing device 100 may determine the current travelling lane of the vehicle using the position information of the vehicle and the image data, but when the current travelling lane of the vehicle is determinable using only the position information of the vehicle, the current travelling lane of the vehicle may be determined using only the position information of the vehicle without performing an operation of collecting image data. However, the present invention is not limited thereto.

In operation S130, the computing device 100 may provide a travelling guide for the vehicle using the current travelling lane of the vehicle determined in operation S120. For example, the computing device 100 may provide a travelling guide for guiding to change lanes or guiding control of the speed of the vehicle based on the current travelling lane of the vehicle.

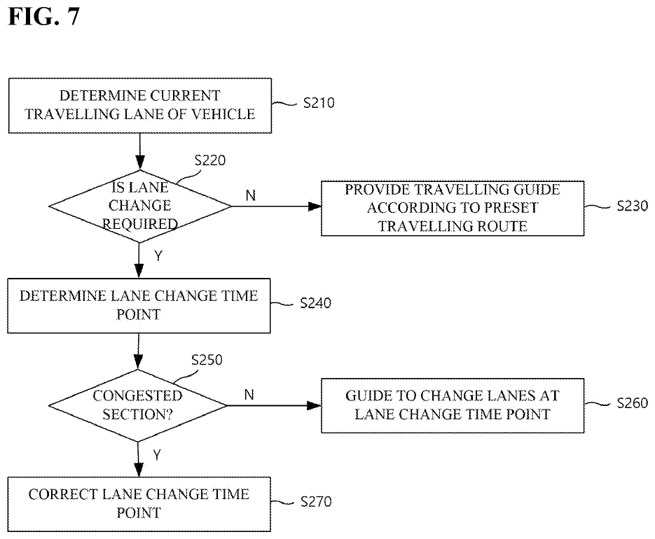

In various embodiments, the computing device 100 may provide a travelling guide for the vehicle based on the current travelling lane of the vehicle and the travelling route preset in the vehicle. Hereinafter, the providing of a travelling guide will be described with reference to FIG. 7.

FIG. 7 is a flowchart showing a method of providing a travelling guide according to a need to change lanes, according to various embodiments;

Referring to FIG. 7, in operation S210, the computing device 100 may determine a current travelling lane of the vehicle using position information of the vehicle collected from the vehicle or driver and image data collected from a camera module provided in the vehicle (e.g., operation S120 of FIG. 3).

In operation S220, the computing device 100 may determine whether a lane change is required for the vehicle using the current travelling lane of the vehicle determined in operation S210 and a travelling route (e.g., an optimized route connecting the current position of the user and the position of a destination input by the user) preset in the vehicle. For example, when it is determined that the preset travelling route of the vehicle is a route in which the vehicle turns left at an intersection 200 m ahead of the vehicle but the vehicle is currently travelling in a straight-only lane, the computing device 100 may determine that there is a need to change the current travelling lane of the vehicle from a straight-only lane to a shared straight/left turn lane or a left turn-only lane.

In addition, when it is determined that a lane change is required, the computing device 100 may calculate the number of required lane changes. For example, the computing device 100 may, in a case of needing to change from a straight-only lane (e.g., the third lane) to a shared straight/left turn lane (e.g., the second lane) or a left turn-only lane (e.g., the first lane), calculate the number of required lane changes.

In various embodiments, the computing device 100 may, upon determining that a lane change is required, calculate the number of required lane changes, in which when the calculated number of lanes is plural, the number of required lane changes may be calculated based on the preset travelling route. For example, when the vehicle currently travelling in a straight-only lane needs to proceed with a left turn, and thus needs to change from the straight-only lane (e.g., the third lane) to a shared straight/left turn lane (e.g., the second lane) or a left turn-only lane (e.g., the first lane), the computing device 100 may calculate the number of required lane changes as one or two. In this case, the computing device 100 may, based on the preset route, calculate the number of required lane changes as one when the next travelling route of the vehicle after the left turn is to proceed straight or with a right turn and induce a lane change to the second lane, which is a shared straight/left turn lane, and may calculate the number of required lane changes as one when the next travelling route of the vehicle after the left turn is to proceed with a left turn and induce a lane change to the first lane, which is a left turn-only lane, thereby facilitating proceeding with the next travelling route.

In operation S230, when it is determined as a result of operation S220 that a lane change is not required, the computing device 100 may provide a travelling guide for guiding to continue travelling in the current travelling lane according to the preset travelling route. However, the present invention is not limited thereto, and when it is determined that a lane change is not required, the computing device 100 may not provide a separate travelling guide.

In operation S240, when it is determined as a result of operation S220 that a lane change is required, the computing device 100 may determine a lane change time point at which the vehicle changes lanes based on the preset travelling route. For example, when the preset travelling route of the vehicle is a route in which the vehicle makes a left turn at an intersection 300 m ahead of the vehicle, the computing device 100 may determine a point in time when the distance between the vehicle and the intersection becomes 150 m as the lane change time point. However, the present invention is not limited thereto.

In various embodiments, the computing device 100 may set a plurality of lane change time points for changing a single lane, and may set different travelling guide providing methods for each lane change time point. For example, the computing device 100 may set three different lane change time points (e.g., a first time point, a second time point, and a third time point) to change a single lane, and set a travelling guide to be output in the form of text at the first time point, set a travelling guide to be output in the form of audio at the second time point after the first time point, and set a travelling guide to be output in the form of text and audio at the third time point after the second time point.

In addition, the computing device 100 may set contents of the travelling guide output at each time point to be different from each other. For example, the computing device 100 may output a travelling guide with content for notifying that a lane change of the vehicle is required at the first time point and the second time point, and may output a travelling guide with content for instructing that the vehicle should change lanes at the third time point. However, the present invention is not limited thereto.

In operation S250, the computing device 100 may, based on the travelling route preset in the vehicle, determine whether a congested section is present on the preset travelling route.

In operation S260, when it is determined as a result of operation S250 that there is no congested section on the travelling route preset in the vehicle, the computing device 100 may provide a travelling guide for guiding to change lanes at the lane change time point determined in operation S240.

In operation S270, when it is determined as a result of operation S250 that there is a congested section on the travelling route preset in the vehicle, the computing device 100 may correct the lane change time point determined in operation S240 and provide a travelling guide for guiding to change lanes at the corrected lane change time point. For example, when the preset travelling route of the vehicle is a route for making a left turn at an intersection 300 m ahead of the vehicle, the computing device 100 may determine a point in time when the distance between the vehicle and the intersection becomes 150 m as the lane change time point. In this case, when it is determined that an area 200 m ahead of the vehicle is congested, based on the intersection, that is, when it is determined that it is difficult to change lanes at the lane change time point, the computing device 100 may change the lane change time point to a point in time when the distance between the vehicle and the intersection becomes 200 m to 250 m rather than 150 m.

In various embodiments, the computing device 100 may determine a state of a congested section for each of a plurality of lanes included in the current travelling road of the vehicle, and provide a travelling guide for guiding to change lanes according to the state of a congested section for each of the plurality of lanes, the current travelling lane of the vehicle, and the preset travelling route.

First, the computing device 100 may determine a state of a travelling congested section for each of a plurality of lanes (e.g., whether it is currently congested or whether a congested section is present within a predetermined distance, etc.), and through this, determine whether a congested section is present in the current travelling lane.

In various embodiments, the computing device 100 may determine whether a congested section is present on the current travelling lane of the vehicle using image data obtained by photographing a space in which the vehicle is currently travelling.

In various embodiments, the computing device 100 may determine the presence or absence of another vehicle adjacent to a target vehicle (e.g., a vehicle used for determining whether a congested section is present on the current travelling lane) and the number of other vehicles using a vehicle communication system, and according to a result of the determination, determine whether a congested section is present on the current travelling lane of the target vehicle.

In various embodiments, the computing device 100 may collect congestion information about a predetermined area including the current position of the vehicle from the external server 300 (e.g., an intelligent transport system (ITS) server) and determine whether a congested section is present on the current travelling lane of the vehicle using the collected congestion information. However, the present invention is not limited thereto.

Thereafter, when it is determined that a congested section is present on the current travelling lane of the vehicle, the computing device 100 may provide a travelling guide for guiding to switch to a lane having no congested section among a plurality of travelling-possible lanes (e.g., a shared straight/left turn lane, a straight-only lane, and a shared straight/right turn lane) according to the preset travelling route (e.g., a straight travelling route).

In various embodiments, the computing device 100 may calculate a congested section for each of the plurality of lanes included in the current travelling road of the vehicle, in which a congestion level (e.g., smooth, normal, congested, etc.) may be determined according to a preset classification criterion, and a travelling guide for guiding to change lanes may be provided according to the determined congestion level.

For example, the computing device 100 may, when the vehicle has “congested” as the congestion level for the current travelling lane, provide a travelling guide for guiding to switch to one, of a plurality of travelling-possible lanes, which has a congestion level of “normal” or “smooth” according to the preset travelling route. In addition, the computing device 100 may, when the vehicle has “normal” as the congestion level for the current travelling lane, provide a travelling guide for guiding to switch to one, of a plurality of travelling-possible lanes, which has a congestion level of “smooth” according to the preset travelling route. However, the present invention is not limited thereto, and the travelling guide for guiding to change lanes may be provided only when the congestion level for the current travelling lane of the vehicle is “congested.”

In various embodiments, when it is determined that a lane change is required, the computing device 100 may determine a lane change time point of the vehicle based on the preset travelling route and provide a travelling guide for guiding to change lanes at the lane change time point, but when the lane change is not performed at the determined lane change time point, the computing device 100 may change the preset travelling route based on the current travelling lane of the vehicle. For example, when the vehicle does not change lanes at the third time point, which is the last lane change time point, among three lane change time points determined to change one lane or when a lane change is performed but on a lane that is not determined by the computing device 100, the computing device 100 may change the preset travelling route based on the current travelling lane of the vehicle and provide the changed preset travelling route.

In general, when it is determined that the vehicle has deviated from a preset route, a new travelling route is provided to the vehicle. However, since the conventional travelling guide service providing system determines the deviation of the vehicle using position information indicating an approximate position of the vehicle, whether there is a deviation of the vehicle is determined only after travelling outside the travelling route to some extent. Accordingly, there is a limitation in providing a new travelling route rapidly.

In contrast, the computing device 100 may, when the vehicle has not currently deviated from the route, but it is determined, based on the travelling route, that the vehicle is to deviate (e.g., when a vehicle required to make a left turn fails to enter a left turn-possible lane, the vehicle is determined to deviate from the preset travelling route), immediately provide a new travelling route so that a route deviation may be more rapidly responded to.

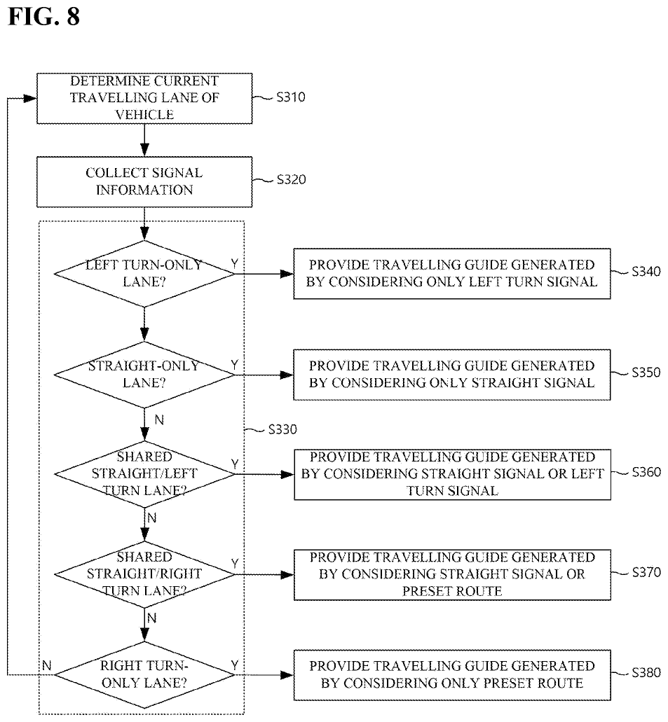

In various embodiments, the computing device 100 may provide a travelling guide for guiding to start or stop the vehicle or control of the speed of the vehicle based on signal information about a traffic light located on a travelling route preset in the vehicle. Hereinafter, it will be described with reference to FIG. 8.

FIG. 8 is a flowchart showing a method of providing a travelling guide using traffic light information according to various embodiments.

Referring to FIG. 8, in operation S310, the computing device 100 may determine a current travelling lane of the vehicle using position information of the vehicle collected from the vehicle or driver and image data collected from a camera module provided in the vehicle (e.g., operation S120 of FIG. 3).

In operation S320, the computing device 100 may collect signal information about one or more traffic lights located on a travelling route preset in the vehicle.

For example, the computing device 100 may obtain position information about one or more traffic lights located on a travelling route preset in the vehicle from precision map data (e.g., FIG. 6) including lanes, lane line information, and traffic light information for each of a plurality of roads.

Thereafter, the computing device 100 may collect image data (e.g., FIG. 5) at every preset unit time from a point in time when the distance between the vehicle and the one or more traffic lights is less than or equal to a reference distance using the position information of the one or more traffic lights and the current position of the vehicle. For example, the computing device 100 may collect image data (e.g., FIG. 5) every second from a point in time when the distance between the vehicle and the one or more traffic lights is less than or equal to 50 m. However, the present invention is not limited thereto.

Thereafter, the computing device 100 may analyze the images of the one or more traffic lights included in the image data to collect signal information of the one or more traffic lights. However, the present invention is not limited thereto, and any method of obtaining signal information from traffic lights positioned on a preset travelling route of the vehicle may be applied.

In operation S330, the computing device 100 may determine an attribute of the current travelling lane of the vehicle. For example, the computing device 100 may determine the attribute of the current travelling lane of the vehicle based on information about lanes included in the precision map data obtained from the external server 300. The computing device 100 may determine whether the current travelling lane of the vehicle determined in operation S310 is a left turn-only lane, a straight-only lane, a shared straight/left turn lane, a shared straight/right turn lane, and a right turn-only lane.

In operation S340, when the attribute of the current travelling lane of the vehicle determined in operation S330 is a left turn-only lane, the computing device 100 may provide a travelling guide generated by considering only a left turn signal in the signal information of the traffic lights obtained in operation S320. For example, the computing device 100 may, when the left turn signal is a travelling-possible signal (e.g., when a signal of a separate left turn traffic light is a green signal or a left turn indication signal is turned on together with a red signal), provide a travelling guide for guiding to start the vehicle, and when the left turn signal is a yellow signal, provide a travelling guide for guiding to decelerate and then stop or to pass through the intersection rapidly, and when the left turn signal is a travelling-impossible signal (e.g., when a signal of a separate left turn traffic light is a red signal or a straight travelling signal is turned on as a green signal), provide a travelling guide for guiding to stop the vehicle. However, the present invention is not limited thereto.

In operation S350, when the attribute of the current travelling lane of the vehicle determined in operation S330 is a straight-only lane, the computing device 100 may provide a travelling guide generated by considering only a straight signal in the signal information of the traffic lights obtained in operation S320. For example, the computing device 100 may, when the immediately preceding signal is a travelling-possible signal (e.g., a green signal), provide a travelling guide for guiding to start the vehicle, and when the immediately preceding signal is a yellow signal, provide a travelling guide for guiding to decelerate and then stop or to pass through the intersection rapidly, and when the immediately preceding signal is a travelling-impossible signal (e.g., a red signal), provide a travelling guide for guiding to stop the vehicle. However, the present invention is not limited thereto.

In operation S360, when the attribute of the current travelling lane of the vehicle determined in operation S330 is a shared straight/left turn lane, the computing device 100 may provide a travelling guide generated by considering only one of a straight signal or a left turn signal according to the preset travelling route. For example, when the attribute of the current travelling lane of the vehicle is a shared straight/left turn lane, and the preset travelling route of the vehicle is a route for travelling straight, the computing device 100 may provide a travelling guide generated by considering only a straight signal in the signal information of the traffic lights obtained in operation S320 (e.g., operation S350). In addition, when the attribute of the current travelling lane of the vehicle is a shared straight/left turn lane, and the preset travelling route of the vehicle is a route for turning left, the computing device 100 may provide a travelling guide generated by considering only a left turn signal in the signal information of the traffic lights obtained in operation S320 (e.g., operation S340). However, the present invention is not limited thereto.

In operation S370, when the attribute of the current travelling lane of the vehicle determined in operation S330 is a shared straight/right turn lane, the computing device 100 may provide a travelling guide generated by considering only a straight signal in the signal information according to the preset travelling route or may provide a travelling guide generated by considering only the preset travelling route regardless of the signal. For example, when the attribute of the current travelling lane of the vehicle is a shared straight/right turn lane, and the preset travelling route of the vehicle is a route for travelling straight, the computing device 100 may provide a travelling guide generated by considering only a straight signal in the signal information of the traffic lights obtained in operation S320 (e.g., operation S350). In addition, when the attribute of the current travelling lane of the vehicle is a shared straight/right turn lane, and the preset travelling route of the vehicle is a route for turning right, the computing device 100 may provide a travelling guide generated by considering only the preset travelling route without considering the signal information of the traffic lights obtained in operation S320. However, the present invention is not limited thereto.

In operation S380, when the attribute of the current travelling lane of the vehicle determined in operation S330 is a right turn-only lane, the computing device 100 may provide a travelling guide generated by considering only the preset travelling route without considering the signal information of the traffic lights obtained in operation S320 (e.g., operation S370). However, the present invention is not limited thereto.

In various embodiments, the computing device 100 may provide a first travelling guide of the vehicle using the current travelling lane of the vehicle and the signal information corresponding to the current travelling lane, and when it is determined that an operation corresponding to the first travelling guide is not performed while exceeding a preset time from a point in time when the vehicle provides the first travelling guide, may provide a second travelling guide for guiding control of the vehicle according to the first travelling guide.

For example, the computing device 100 may, when a first travelling guide for guiding to decelerate the speed of the vehicle is provided in consideration that the attribute of the current travelling lane is a left turn-only lane and the left turn signal is a travelling-possible signal, but it is determined that the speed of the vehicle is not decreased, a second travelling guide for notifying that a left turn signal is currently a travelling-impossible signal and guiding to decrease the speed of the vehicle may be provided.

In addition, the computing device 100 may, when a first travelling guide for guiding to start the vehicle in consideration that the attribute of the current travelling lane is a straight-only lane and the straight signal is a travelling-possible signal, but it is determined that the vehicle is not started, a travelling guide for notifying that a straight signal is currently a travelling-impossible signal and guiding control to start the vehicle may be provided.

In various embodiments, the computing device 100 may output the first travelling guide and the second travelling guide in the form of audio, text, and vibrations such that the output strength of the second travelling guide is higher than the output strength of the first travelling guide. However, the present invention is not limited thereto.

Similarly, according to the disclosed embodiment, at least one of a result of situation determination of the computing device 100 and information about travelling according to the result may be provided to the driver of the vehicle using an output device, such as a display or audio. For example, according to the disclosed embodiment, the vehicle may perform autonomous travelling (or semi-autonomous travelling) through the control of the computing device 100. In this case, the driver may identify a status of the situation determination of the computing device 100 and the corresponding travelling plan in advance based on the output information, and when there is an error in the situation determination of the computing device 100 or the corresponding travelling plan, correct the error, or control the travelling by changing to a manual control mode, or transmit manual control information in an interrupt method, but the present invention is not limited thereto.

The method of providing a travelling guide using position information and traffic light information described above has been described with reference to the flowchart shown in the drawings. For brief description, the method of providing a travelling guide using position information and traffic light information is illustrated and described using a series of blocks. However, the order of the blocks is not particularly limited, and some blocks may be performed simultaneously or in a different order from the order illustrated and described in this specification. In addition, new blocks not described in this specification and drawings may be added, or some blocks may be deleted or changed.

Although exemplary embodiments of the present invention have been described in detail above with reference to the accompanying drawings, those of ordinary skill in the technical field to which the present invention pertains should be able to understand that various modifications and alterations may be made without departing from the technical spirit or essential features of the present invention. Therefore, it should be understood that the embodiments described above are illustrative in all respects rather than restrictive.

1. A method of providing a travelling guide using position information of a vehicle and traffic light information, which is a method performed by a computing device, the method comprising:
collecting image data obtained by photographing a space in which a vehicle is currently travelling;
determining a current travelling lane of the vehicle using the image data and position information of the vehicle; and
providing a travelling guide for the vehicle using the current travelling lane of the vehicle.

2. The method of claim 1, wherein the providing of the travelling guide for the vehicle includes:
determining whether a lane change is required and the number of required lane changes based on the current travelling lane of the vehicle and a travelling route preset in the vehicle; and
when it is determined that the lane change is required, providing a travelling guide for guiding to change lanes by the determined number of required lane changes.

3. The method of claim 2, wherein the providing of the travelling guide for guiding to change lanes includes, when it is determined that the lane change is required, determining a lane change time point of the vehicle based on the preset travelling route, wherein the determined lane change time point is corrected based on whether there is vehicle congestion on the preset travelling route.

4. The method of claim 2, wherein the providing of the travelling guide for the vehicle includes, when it is determined that the lane change is required, determining a lane change time point of the vehicle based on the preset travelling route, and when the lane change is not performed at the determined lane change time point, changing the preset travelling route based on the current travelling lane of the vehicle.

5. The method of claim 1, further comprising collecting signal information about one or more traffic lights located on a travelling route preset in the vehicle,
wherein the providing of the travelling guide for the vehicle includes providing a travelling guide for guiding to start or stop the vehicle or guiding control of a speed of the vehicle based on at least one of the current travelling lane of the vehicle, the travelling route preset in the vehicle, and the signal information.

6. The method of claim 5, wherein the providing of the travelling guide for the vehicle includes:
when the current travelling lane of the vehicle is a left turn-only lane, providing a travelling guide generated by considering only a left turn signal in the signal information;
when the current travelling lane of the vehicle is a shared straight/left turn lane, providing a travelling guide generated by considering only a straight signal in the signal information or a travelling guide generated by considering only the left turn signal in the signal information according to the preset travelling route;
when the current travelling lane of the vehicle is a right turn-only lane, providing a travelling guide generated by considering only the preset route regardless of the signal information; and
when the current travelling lane of the vehicle is a shared straight/right turn lane, providing a travelling guide generated by considering only the straight signal according to the preset travelling route or a travelling guide generated by considering only the preset route regardless of the signal information.

7. The method of claim 5, wherein the providing of the travelling guide for the vehicle includes providing a first travelling guide for the vehicle based on at least one of the current travelling lane of the vehicle, a travelling route preset in the vehicle, and the signal information, and when it is determined that the vehicle has not performed an operation corresponding to the first travelling guide while exceeding a preset time after the providing of the first travelling guide, providing a second travelling guide for guiding to control the vehicle according to the first travelling guide;

8. The method of claim 5, wherein the collecting of the signal information about the one or more traffic lights includes:
collecting position information about the one or more traffic lights located on the preset travelling route from precision map data including lanes, lane line information, and traffic light information for each of a plurality of roads;
collecting the image data every preset unit time from a point in time at which a distance between the vehicle and the one or more traffic lights is less than or equal to a reference distance using the position information about the one or more traffic lights and a current position of the vehicle; and
analyzing images for the one or more traffic lights included in the image data to collect the signal information about the one or more traffic lights.

9. The method of claim 1, wherein the determining of the current travelling lane of the vehicle includes:
determining a current position of the vehicle and a moving direction of the vehicle using the position information of the vehicle; and
analyzing a road on which the vehicle travels and surrounding geographical features included in the image data using a pre-trained artificial intelligence (AI) model to determine the current travelling lane of the vehicle.

10. An apparatus comprising a memory and a processor, wherein:
the memory stores one or more instructions; and
the processor executes the one or more instructions stored in the memory and performs the method of claim 1 by executing the one or more instructions.

11. A computer program stored in a computer-readable recording medium to perform the method of claim 1 in combination with a computer which is hardware.
